(19) United States
(12) Patent Application Publication
(10) Pub. No.: US 2013/0046899 A1
(43) Pub. Date: Feb. 21, 2013

(54) IPV6 LAN-SIDE ADDRESS ASSIGNMENT POLICY

(71) Applicants: KENDRA S. HARRINGTON, Irvine, CA (US); Dan T. Wang, Irvine, CA (US)

(72) Inventors: KENDRA S. HARRINGTON, Irvine, CA (US); Dan T. Wang, Irvine, CA (US)

(21) Appl. No.: 13/210,922

(22) Filed: Aug. 16, 2011

(51) Int. Cl. G06F 15/16

(52) U.S. Cl. 709/230

(57) ABSTRACT

Techniques are presented for assigning a network address to a computing device. In one embodiment, a network device such as a router may be responsible for assigning a network address (e.g., an IP address) to a connected computing device. For example, in IPv6, the network device provides the computing device with a 64-bit prefix that the computing device then uses to generate a 128-bit unique IP address. The network device typically receives this prefix from another server located in the WAN. In case of a communication failure with the WAN, the network device may be unable to attain the correct prefix. Instead of assigning a random prefix that may cause a conflict if the computing device uses the incorrect prefix on the WAN, the network device may assign a different IP address using a different communication protocol—e.g., IPv4. The computing device can then use IPv4 to access both the LAN and the WAN without risking a conflict.

### TECHNICAL FIELD

Embodiments presented in this disclosure generally relate to assigning a network address to a computing device (e.g., client devices).

### BACKGROUND

The continuous growth of the Internet requires that its overall architecture evolve to accommodate the growing numbers of users, applications, appliances, and services. The current Internet Protocol version 4 (IPv4) address space is unable to satisfy the current increase in the number of computing devices, such as Internet-enabled wireless digital assistants, home and industrial appliances, Internet-connected transportations, integrated telephony services, and distributed computing or gaming.

The lifetime of IPv4 has been extended using techniques such as address reuse with network address translation (NAT) and temporary-use allocations. While providing some relief, these techniques complicate communicating within local access networks (LAN) as well as remote access to devices on the LAN or subnet. Internet Protocol version 6 (IPv6), which is explained in “IP Version 6 (IPv6) Addressing Architecture” Request for Comments (RFC) 3513, solves these complications by providing a unique global address to every computing device. IPv6 increases the number of network address bits from 32 bits (in IPv4) to 128 bits—i.e., 2¹²⁸ unique IP addresses. In one implementation, a network device, such as a home network router, receives a 64-bit prefix from a server located in the wide access network (WAN) which the network device then relays to a connected computing device. The computing device may use the prefix to formulate the 128 bit IPv6 address for connecting to the WAN (i.e., the Internet). However, if the connection to the IPv6 server in the WAN fails, then the network device may not provide the correct prefix to the computing device. If the computing device uses an incorrect prefix to formulate an IP address and subsequently connects to the WAN, it may cause conflicts with other devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments and are therefore not to be considered limiting of its scope, for the disclosure may admit to other equally effective embodiments.

FIG. 1 illustrates a network, according to one embodiment;

FIG. 2 illustrates a system for assigning a network address to a client device, according to one embodiment;

FIG. 3 is a system diagram of the network of FIG. 1, according to one embodiment;

FIG. 4 is a flow illustrating an address assignment process, according to one embodiment; and

FIG. 5 illustrates a flow for renewing a lease using the second communication protocol, according to one embodiment.

### DESCRIPTION

### Overview

One embodiment presented in this disclosure includes a method for assigning a network address for connecting to a computer network. This method may include determining whether the portion of the network address was received via the communication network. If the portion of the network address was received, the method transmits to a computing device the portion of the network address based on a first communication protocol. Otherwise, the method generates the network address based on a second communication protocol.

One embodiment presented in this disclosure includes network device that generates at least a portion of a network address associated with a communication network. The network device includes a network address assignor configured to determine whether the portion of the network address was received via the communication network. If the portion of the network address was received, the network address assignor transmits to a computing device the portion of the network address based on a first communication protocol. Otherwise, the network address assignor generates the network address based on a second communication protocol.

One embodiment presented in this disclosure includes a computer program product for generating at least a portion of a network address associated with a communication network. The computer program product includes computer code that determines whether the portion of the network address was received via the communication network. The computer program product includes computer code that, if the portion of the network address was received, transmits to a computing device the portion of the network address based on a first communication protocol. The computer program product includes computer code that, otherwise, generates the network address based on a second communication protocol. The computer program product further includes a computer readable medium that stores the computer code.

### Description of Example Embodiments

Embodiments presented in this disclosure provide techniques for assigning an address to a client device on a network when a first network communication protocol is unavailable. For example, when assigning an address using Internet Protocol version 6 (IPv6), the client device receives a prefix from a network edge device, i.e., a router. In one embodiment, the client device uses the prefix to formulate a unique IP address that is globally addressable. In another embodiment, the router may use an IPv6 Dynamic Host Configuration Protocol (DHCP) server to generate an IP address that is then sent to the client device. In either case, for private home networks, the router typically receives the prefix from a device located in the WAN (e.g., from a server provided by an Internet Service Provider (ISP) external to the home network). If that server is unavailable, the router may not know the correct prefix to assign. In one embodiment, the router may transmit a predetermined prefix to the client device or generate a random prefix if it does not receive the correct prefix from the server in the WAN. In either case, the resulting IP address is a Unique Local Address (ULA) which may not be globally unique. This does not, however, create a problem for communication between devices on the LAN or subnet since the ULA uniquely identifies each client device connected to the router on the LAN. But as the use of IPv6 becomes more commonplace, the client device, which may not know that the received prefix is invalid, may attempt to use the IP address on the WAN. If another device on the WAN was also assigned the same prefix, the likelihood of a conflict greatly increases. Note, the process of assigning a ULA is described in detail in “Unique Local IPv6 Unicast Addresses” RFC 4193.

In one embodiment, rather than assigning an invalid prefix, the router assigns an IP address based on a different communication protocol—e.g., IPv4. Advantageously, many client devices that are IPv6 compatible are also backwards compatible with IPv4. If such a device is assigned an IPv4 network address, it assumes the router is an IPv4 only device. Moreover, the client device still maintains the ability to communicate with other devices on the LAN or subnetwork.

For the foreseeable future most routers will support both IPv4 and IPv6. Accordingly, if the client device cannot create a unique global IPv6 address, it may use IPv4 to access and traverse the WAN. For example, if a prefix could not be assigned because the relevant DHCP server for IPv6 is down but the DHCP server for IPv4 is still operating, then the router may assign an IPv4 address that allows the client device to access the WAN using that communication protocol.

In another embodiment, a router that includes an IPv4 DHCP server may change the lease duration associated with the IPv4 network address assigned to the client device. For example, the IPv4 address may be assigned a lease time of only a few minutes. Once the lease expires, the client device submits a request to the router to renew the lease. Meanwhile, the networking device may constantly monitor the WAN connection. If the communication failure which necessitated switching communication protocols has been resolved, the router may assign an IPv6 address rather than renewing the lease for the IPv4 address.

Further, if the communication failure persists, the router may assign a longer duration each time the lease is renewed. However, for each subsequent request, the lease duration may be increased until a maximum duration is reached.

In one embodiment, even if the correct prefix is received and assigned by the router, the WAN connection may subsequently fail. Specifically, the servers in the WAN that support IPv6 may fail but the servers that support IPv4 may still function. The router may detect this failure, and when receiving requests for an IPv6 address, the router may deny these requests and instead assign IPv4 addresses to the client devices. In this manner, the router may switch from assigning a correct, but nonfunctioning, IPv6 address to an IPv4 address that can transmit data on the WAN.

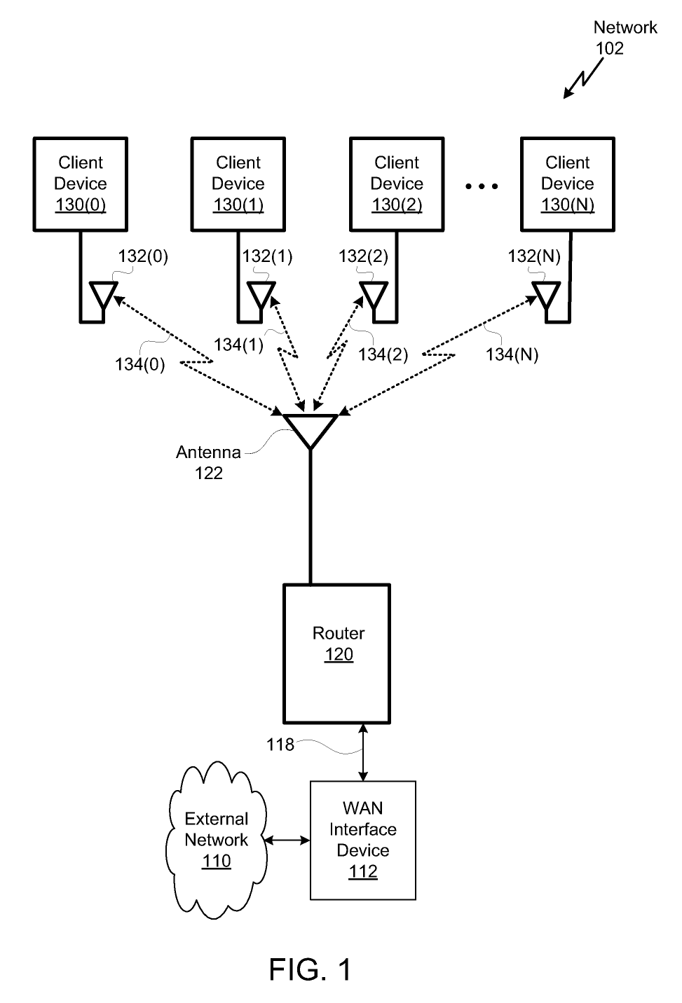

FIG. 1 illustrates a network 102, according to one embodiment. As shown, the network 102 comprises a router 120, one or more client devices 130 and a WAN interface device 112, coupled to the external network 110. The WAN interface device 112 may implement a cable modem, digital subscriber line (DSL) modem, fiber to the home interface, or any other technically feasible device that provides digital network connectivity to the external network 110. The WAN interface device 112 is coupled to the router 120 via a network interface 118. In one embodiment, the network interface 118 implements the well-known Ethernet standard.

The router 120 implements a wireless network interface coupled to antenna 122, which is configured to convert electrical signals to electromagnetic signals for transmitting data packets, and electromagnetic signals to electrical signals for receiving data packets. The antenna 122 may comprise plural independent radiator structures, each having a separate radiation pattern for implementing spatial multiplexing. In one embodiment, the wireless network interface implements one or more well-known standards, such as the Institute of Electrical and Electronics Engineers (IEEE) standard 802.11, which defines a system for wireless local area networking. The antenna 122 is configured establish wireless client links 134 to antennas 132 coupled to corresponding client devices 130. The router 120 implements Ethernet layer 2 switching for wireless data packets forwarded among client devices 130 as well as Internet Protocol (IP) layer 3 routing between an IP domain associated with the network 102 and the external network 110. In this configuration, the router 120 provides related services and protocols, such as DHCP, NAT and the like.

Although a router 120 is shown, the disclosure is not limited to such, but rather any network device that performs the functions described herein is contemplated by this disclosure. Similarly, the techniques discussed in this disclosure are not limited to client devices 130 that wirelessly connect to a router but may be any computing device that performs the functions described herein by connecting wirelessly or by wire to a network device.

### Stateless and Stateful Address Autoconfiguration

Switching from IPv4 to IPv6 offers several advantages such as an address space that increases from 2³² to 2¹²⁸ unique IP address, simplified address assignments, simplified network renumbering and simplified router announcements. This section discusses the address assignment performed between a host (e.g., client device 130) and a router (e.g., router 120).

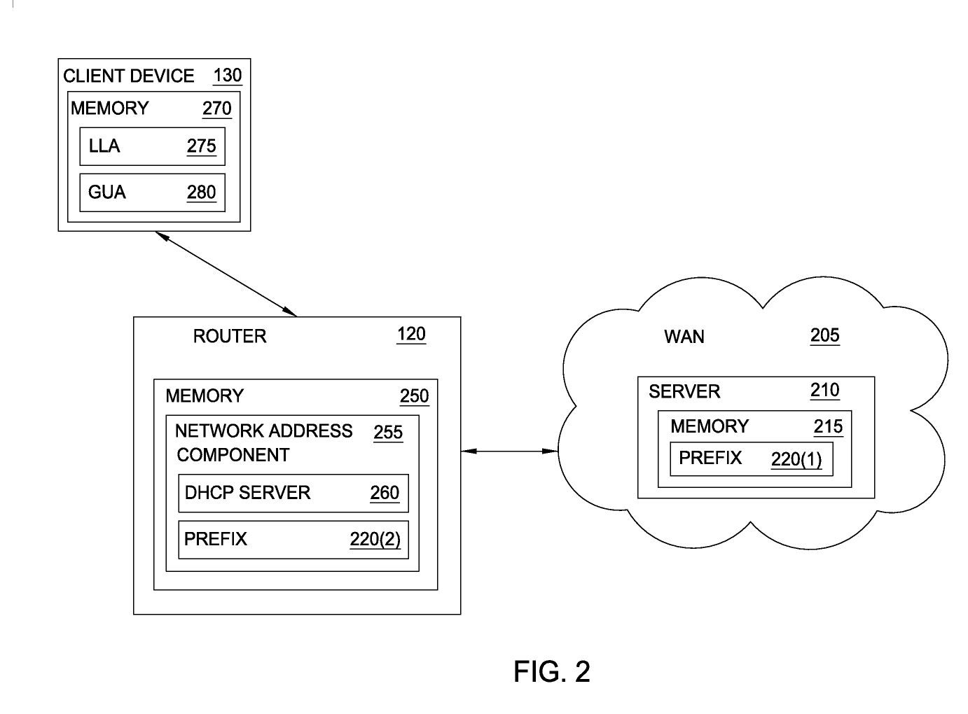

FIG. 2 illustrates a system for assigning a network address to a client device, according to one embodiment. As shown, the router 120 is an edge device between the LAN (i.e., network 102) comprising of one or more client devices 130 and the WAN 205. Memory 250 includes a network address component 255 that aids in assigning a network address to the client device.

IPv6 supports two primary mechanisms for assigning network addresses. The first is stateless address autoconfiguration. It is referred to as “stateless” because this mechanism for assigning a network address may begin from a dead start with no information or state needed. Unlike IPv4, stateless address autoconfiguration dynamically assigns an IP address without the use of a DHCP server. Stateless address autoconfiguration is described in more detail in “IPv6 Stateless Address Autoconfiguration” RFC 4862. The second address assignment process is stateful address configuration which is similar to DHCP in IPv4. Specifically, stateful address configuration uses a different version of DHCP—DHCPv6—along with a DHCP server to assign IP addresses to host devices. Stateful address configuration is described in more detail in “Dynamic Host Configuration Protocol for IPv6 (DHCPv6)” RFC 3315.

Stateless address autoconfiguration begins when the client device 130 generates a link-local address (LLA) 275 which is one of the two types of local-use IPv6 addresses. The LLA 275 is used on the LAN to provide an address for initial communication and configuration. In IPv6, the LLA 275 includes “1111 1110 10” for the first ten bit values as well as a 64 bit interface identifier that is typically derived from a MAC address associated with the client device—i.e., the MAC address for the Network Interface Card on the client device 130—though it is not limited to such. Because the client device 130 may assign itself the LLA 275, it may not be a unique address. Accordingly, the client device 130 may perform a uniqueness test (e.g., Duplicate Address Detection) to discover whether another client device 130 on the network 102 is using the same LLA 275. Because a LLA 275 is not routed, it provides the client device access to the LAN but not to the WAN 205—e.g., the Internet.

A client device 130 may listen for Router Advertisements that are sent periodically by routers, or may send a Router Solicitation to query a router for information using the self-assigned LLA 275. Accordingly, in the former situation, the client device 130 may receive all the information necessary to generate a globally unique address (GUA) 280 without first sending a request to the router 120. The GUA 280 is an IP address that is unique for any WAN 205 using the IPv6 protocol as a communication protocol and may also be referred to as the Global Address.

To formulate a GUA 280 for IPv6, the client device 130 needs a prefix 220 from a device such as router 120 or server 210. This prefix 220 is a 64 bit value (8 octets) that the client device 130 then combines with another 64 bit value to formulate the 128 bit GUA 280. Typically, the prefix 220 is combined with a derivative of the MAC address associated with the client device—i.e., the MAC address derivative forms the other 8 octets of the GUA 280. In this manner, the IP address assigned to the client device 130 is associated with an identifier of the device, which is another advantage over IPv4 where the IP address is unrelated to the client device to which it is assigned. The value for prefix 220(2) stored in router 120 is set by the value of the prefix 220(1) stored in the server 210. Accordingly, if the server 210 wants to change the IP address of the client device 130 to include a different prefix, then the server 210 sends the new prefix to the router 120.

The router 120 may transmit the prefix 220(2) to a client device in an unsolicited Router Advertisement or in a Router Advertisement in response to a Router Solicitation from the client device 130. In either case, the client device 130 receives at least a portion of its global IP address (i.e., GUA 280) from the router 120 and the server 210. The rest of the GUA 280 may then be generated by the client device 130 in any desired manner, for example, using the IEEE EUI-64 standard. In this manner, stateless address autoconfiguration allows the client device 130 to determine its own GUA 280 that is unique for the entire addressable space defined by IPv6.

The Router Advertisement may also contain a flag that instructs the client device 130 to use stateful autoconfiguration DHCPv6) to formulate the GUA 280. Also, the client device 130 may use stateless autoconfiguration for IP address formulation if a DHCPv6 server providing IP addresses is not found, even if a DHCPv6 server is available for other configuration information. IPv6 also supports a stateless DHCPv6 configuration, which is explained in “Stateless Dynamic Host Configuration Protocol” RFC 3736, but will not be discussed here.

DHCPv6 works as a client/server model. That is, the client transmits to the server (i.e., a router operating a DHCP server) Solicit or Request messages that the server then responds to with Advertise and Reply messages. At the conclusion of the stateful autoconfiguration, the DHCP server has transmitted to the client device (i.e., a DHCP client) configuration information including the IPv6 GUA and a duration that the GUA is valid. Thus, unlike in stateless autoconfiguration, the GUA is transmitted to the client device rather than the client device formulating the GUA from a received prefix.

In an example communication between a DHCPv6 enabled server (i.e., router 120) and the client device 130, the client device 130 begins by sending a Solicit message (using the LLA 275) to discover available DHCP servers. Assuming that the DHCP server 260 in the network address component 255 is available, it responds with an Advertise message. The client device 130 then chooses a server by sending a request message. Assuming the client device 130 chooses DHCP server 260, the server 260 then sends a Reply message containing the GUA 280 and other configurations. That is, the DHCP server 260 “rents” out the GUA 280 to the client device 130. Once the lease expires, the client device 130 either renews the lease or finds another DHCP server to provide the GUA 280. Moreover, like in stateless autoconfiguration, the GUA 280 is also based on the prefix 220. However, unlike stateless autoconfiguration, the DHCP server 260 transmits the GUA 280 to the client device 130 rather than the client device 130 formulating the GUA from a received prefix.

Because the client device 130 sends out a broadcast message to all available DHCP servers, multiple DHCP servers may respond with offers. The client device listens for all the different Advertise messages that it may receive, but accepts only one. The client device 130 then sends a Request message back to the chosen DHCP server, which in this case is DHCP server 260. Finally, the chosen DHCP server 260 replies back to the client device 130 with a message that may include the GUA 280 and the lease duration as well as any other configuration information that the client device 130 has requested. Because most DHCPv6 and DHCPv4 servers assign a finite lease duration, once the lease expires the GUA 280 is no longer valid. This forces the client device 130 to again contact the DHCP server 260 (or different DHCP server) to acquire a new lease duration. The client device 130 may contact the DHCP server 260 to renew the lease either before or after the lease expires.

DHCPv4 for use in the IPv4 communication protocol follows a similar process as outlined above. Additional details of DHCPv4 may be found in “Dynamic Host Configuration Protocol (DHCPv4)” RFC 3456.

For a router that operates as an edge device, for example, between a private home LAN and the Internet, the router may receive the necessary prefix from a different server (or router) located within the WAN. This is true for both stateless and stateful address autoconfigurations. Accordingly, during start-up or during a predefined interval, the router 120 may use its connection to the WAN 205 to receive the prefix 220(1) from the server 210. If the router 120 is unable to communicate with the server 210, then neither the stateful nor stateless autoconfigurations will yield the correct GUA 280. The network address component 255 in the router 120 may still respond to either a router solicitation during a stateless autoconfiguration or a broadcast message during a stateful autoconfiguration, but the resulting IP address is not assured to be unique within the WAN.

### Assigning a GUA Without the Correct Prefix

Currently, the Internet is transitioning from using IPv4 to IPv6 as the primary network layer protocol. During this process, many routers controlling the flow of network layer packets are configured to route packets using both communication protocols. Alternatively, IPv4 data packets may use one network of servers while IPv6 data packets use a different network of servers. In either case, IPv4 data packets may be conveyed to IPv6 data packets (or vice versa) using a process called tunneling. If a router or server wants to communicate between devices using different protocols, it inserts a packet of one of the communication protocols into the data carrying portion of a packet of the second communication protocol. This hybrid packet may then be transmitted using the second communication protocol. Because of this dual-nature, for the foreseeable future a client device 130 that is compatible with both communication protocols may use either to communicate with the WAN 205.

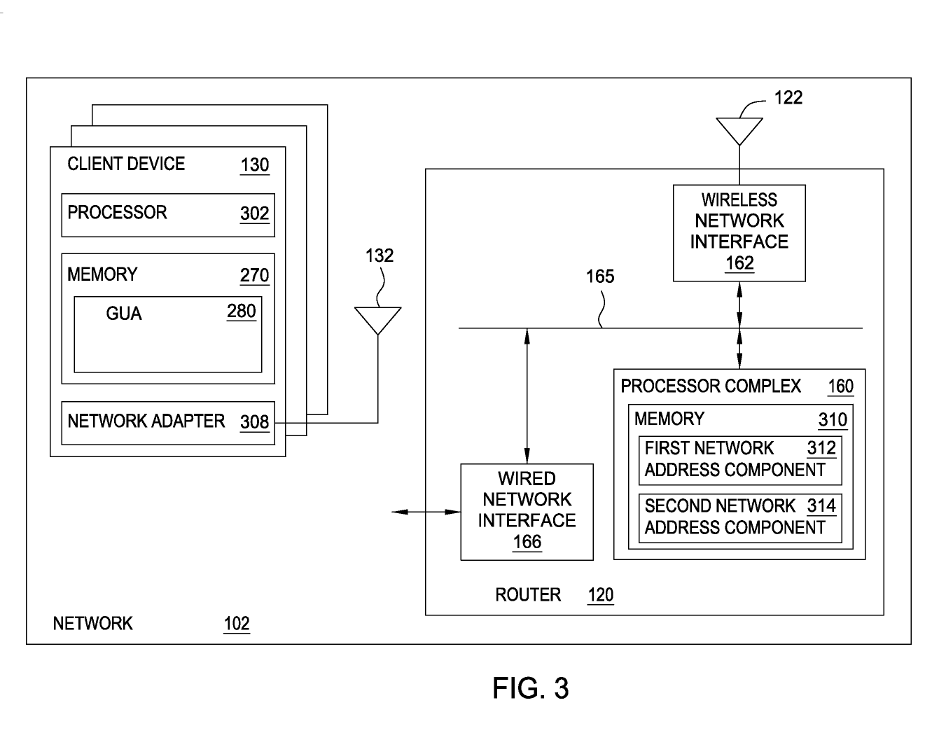

FIG. 3 is a system diagram of a network, according to one embodiment. Like the system illustrated in FIG. 1, a plurality of client devices 130 may wirelessly connect to a router 120. Each client device 130 also includes a processor 302, memory 270 and network adapter 308. The processor 302 may be a central processing unit (CPU) while the network adapter 308 may be a network interface controller or card. Moreover, the network adapter 308 may be communicatively coupled to the router 120 via the antenna 132. Memory 270 may include non-volatile memory for storing persistent programs, program state, and configuration information as well as random access memory (RAM) for storing temporary or volatile data. The memory 270 stores the GUA 280 which uniquely identifies a location of the client device 130 in the WAN 205.

The router 120 comprises a processor complex, 160, a wireless network interface 162, and a wired network interface 166. An interconnect 165 is configured to transmit data among the processor complex 160, wireless network interface 162, and wired network interface 166. The wired network interface 166 is configured to transmit data packets via network interface 118, based on data received via the interconnect 165. The wired network interface 166 is also configured to receive data packets from the network interface 118 and transmit contents of the received data packets to the processor complex 160 via the interconnect 165. The wireless network interface 162 is configured to transmit data packets, based on data received via the interconnect 165, to one or more network devices within range. The wireless network interface 162 is also configured to receive data packets from the one or more network devices and then transmit contents of the received packets to the processor complex 160. The wireless network interface 162 is coupled to an antenna 122. In one embodiment, the router 120 may include a wireless network interface for connecting the network interface 118.

The processor complex 160 comprises a central processing unit (CPU), non-volatile memory for storing persistent programs, program state, and configuration information, random access memory (RAM) for storing temporary or volatile data, and an interface to the interconnect 165. In one embodiment, the processor complex 160 is configured to execute an operating system and applications that provide routing services. The routing services may include, for example, data packet forwarding between the network interface 118 and the wireless network interface 162. The packet forwarding services may include, without limitation, bridging among the one or more network devices via the wireless network interface 162.

In certain embodiments, the router 120 comprises one or more integrated circuits that implement respective functions of the router 120. For example, the processor complex 160, wired network interface 166 and wireless network interface 162 may be integrated into a single integrated circuit.

The processor complex 160 also includes a memory 310 with a first network address component 312 and a second network address component 314. In one embodiment, the first network address component 312 is configured to assign IP addresses using the IPv6 communication protocol (i.e., the network address component 255) while the second network address component 314 is configured to assign IP addresses using the IPv4 communication protocol. Moreover, the first network address component 312 may perform both stateless and stateful address autoconfiguration. In another embodiment, the first network address component 312 is configured to perform only one of stateless or stateful address autoconfiguration. Further, while the first and second network address components 312, 314 are shown as separate components, they may be implemented in a single component. Alternatively, each component may be further divided into different components based on, for example, their functions. In one embodiment, the first network address component 312 may be divided into a DHCPv6 server portion and a second portion for handling Router Specification and Advertisements in stateless address autoconfiguration.

In one embodiment, the wired network interface 166 is connected to a server within the WAN 205 that provides to the first network address component 312 a prefix used in IPv6 address assignment. Moreover, the router 120 may use the wired network interface 166 to monitor the WAN 205 connection. For example, the wired network interface 166 may be compatible with both the IPv4 and IPv6 communication protocols and may detect if there is a communication failure with the WAN 205 using one or both of the protocols. A communication failure may be that the router 120 never receives the prefix from a server in the WAN 205. Another failure may be that data packets sent using one of the communication protocol fail to reach their destination (or are not received). This scenario could include a physical failure of the communication network—e.g., a removed cable or powered-down servers—as well as packet loss due to overtaxed network devices. Moreover, a communication failure may affect only the portion of the WAN 205 that uses one of the IP protocols. That is, the router 120 or client device 130 may be unable to communicate on the WAN 205 using IPv6 but may be able to using IPv4. The wired network interface 166 may then inform the first and second network components 312, 314 of the communication failure.

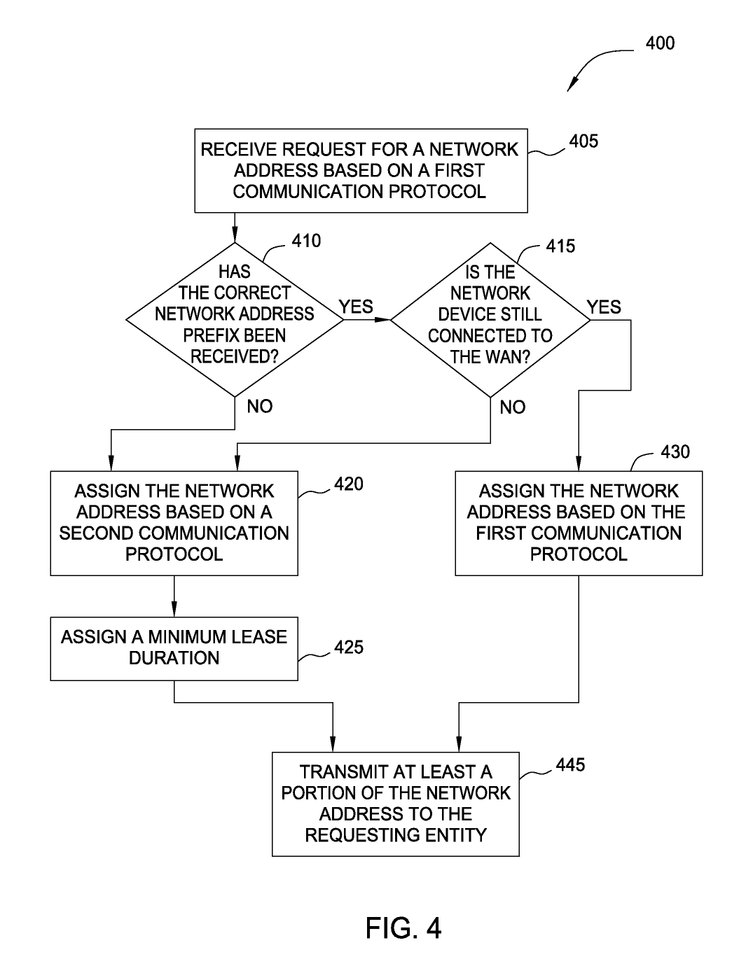

FIG. 4 is a flow illustrating an address assignment process, according to one embodiment. At step 405, the first network address component 312 receives a request for a network address that is assigned based on a first communication protocol. In one embodiment, the first network address component 312 assigns a prefix using either stateful or stateless autoconfiguration to a requesting client device 130. Alternatively, the first network address component 312 may broadcast the prefix in a Router Advertisement without ever receiving the request from the client device 130. Before a prefix may be assigned, however, the router 120 may need to receive the prefix from a server located within the WAN 205.

At step 410, the router 120 determines if the prefix has been received. If it has been received, the router 120 then determines if the connection to the WAN 205 is still functional. That is, the router 120 may have previously received the prefix but still ensures, at step 415, that the WAN 205 connection is still functional before sending the prefix to the client device 130. Advantageously, this functionality prevents the router 120 from assigning to the client device 130 a GUA 280 that may be useless for communicating with the WAN 205. For example, the client device 130 may be unable to traverse the WAN 205 using an IPv6 GUA 280 but may be able to communicate using an IPv4 address.

If either step 410 or 415 inform the router 120 that there was a communication failure, then at step 420, the router 120 refrains from transmitting a prefix to the client device 130 using the first network address component 312. Instead, the router 120 may use the second address network component 314 to assign an IP address based on the second communication protocol. For example, the router 120 may, in a sense, turn off the first network address component 312 such that it does not communicate with the client device 130. The client device 130 then assumes that the router 120 is not compatible with the first communication protocol—IPv6. The router 120 then sends an IPv4 address to the client device 130 using the second network address component 314, which may perform the functions of a DHCPv4 server.

Assigning an IPv4 address to the client device 130 even though the client device 130 may have requested an IPv6 address advantageously avoids possible conflicts and allows connection to the WAN 205 using IPv4. Moreover, assigning an IPv4 does not negatively impact the ability of the client device 130 to communicate within the network 102. For example, the router 120 may be configured for routing between client devices 130 using IPv4 addresses and client devices 130 using IPv6 addresses (i.e., perform tunneling). Accordingly, the router 120 facilitates communication in the LAN between two client devices 130 that use a different communication protocol.

In one embodiment, before assigning the network address based on the second communication protocol, the router 120 may determine that the client device 130 is compatible with the second communication protocol. For example, a client device 130 may only be compatible with the first communication protocol—IPv6. In that case, the router 120 may simply refuse to assign any network address or transmit a predetermined or random prefix to the client device 130. This may cause a conflict if the client device 130 attempts to use the ULA to access the Internet, but the address at least allows the client device 130 to communicate with other client devices 130 in the network 102 or subnet.

At step 425, the second network address component 314 may assign a lease duration to the assigned IP address. With DHCPv4, requiring the client device 130 to renew the lease enables the DHCPv4 server to make sure that it is efficiently using its assigned addressable space. In other words, if a client device 130 (or a networking device) does not contact the DHCP server to renew the lease, the DHCP server may deallocate the IP address assigned to the client device 130 and mark it as available. This frees the address to be assigned to any other requesting computing or networking device. This applies to both a DHCP server in the WAN 205 and a DHCP server managing a LAN—e.g., the second network address component 314.

When assigning the IPv4 address to the client device, the second network address component 314 may assign a short lease duration for the address. For example, the second network address component 314 may assign a lease duration less than a minute or less than 15 minutes. This is in contrast to a typical lease duration of 24 hours. Doing so allows the client device 130 to quickly “upgrade” to an IPv6 address should the prefix become available or the WAN 205 connection is established.

If the queries of step 410 and 415 are both answered in the affirmative, then at step 430 the network address is assigned based on the second communication protocol—i.e., IPv6 stateless or stateful autoconfiguration.

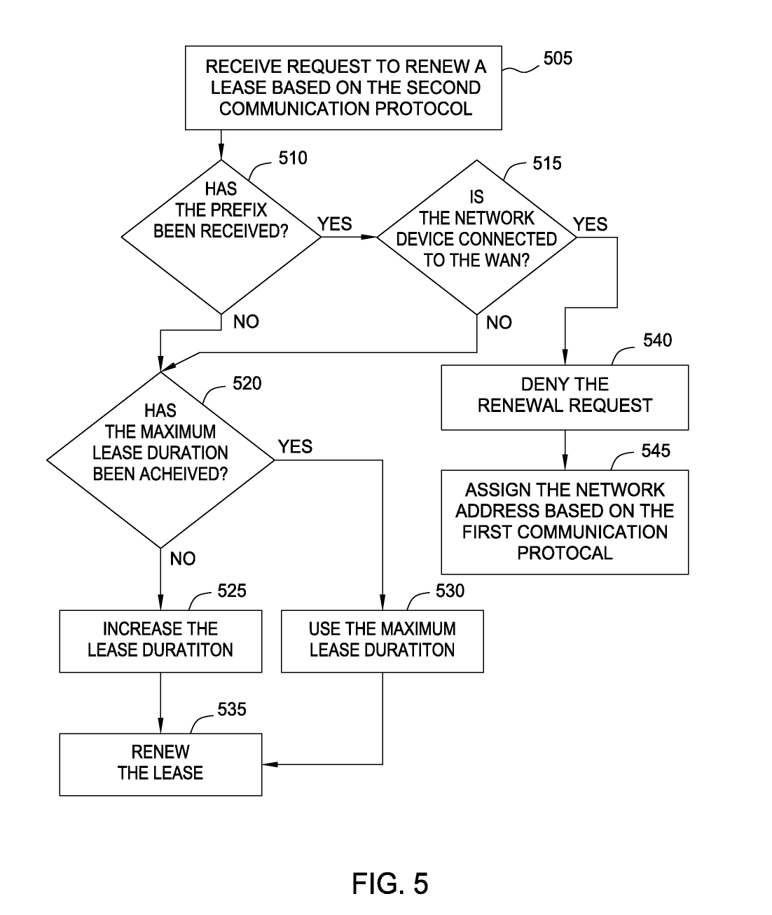

FIG. 5 illustrates a flow for renewing a lease using the second communication protocol, according to one embodiment. At step 505, a client device 130 may send a request to the second network address component 314 to renew the lease. If the lease has not been previously renewed, then the lease duration may correspond to a minimum lease duration that was assigned in step 425 of the method 400 shown in FIG. 4.

At step 510, the second network address component 314 may communicate with the first network address component 312 to determine whether first network address component 312 has received the correct prefix. If it has, then at step 515 the second network address component 314 may receive status information on the ability of the router 120 to communicate with the WAN 205. For example, the wired network interface 166 may alert the second network address component 314 when the router 120 (or client devices 130) cannot communicate with the WAN 205 using the first communication protocol—e.g., IPv6.

If the router 120 has received the correct prefix and the WAN 205 connection is functional, the second network address component 314 may deny the lease at step 540. Assuming the requesting client device 130 is capable of using the first communication protocol, at step 545, the router 120 may instruct the first network address component 312 to then assign the IP address using the first communication protocol. In one embodiment, the first network address component 312 may send out a Router Advertisement that includes the prefix. The client device 130 may receive the prefix and construct the GUA 280 based on IPv6 as discussed previously.

In another embodiment, after the lease renewal is denied, the client device 130 may be configured to send a request to the router 120 for at least a portion of an IPv6 address. The router 120 may enable the first network address component 312 which responds to the request using either stateless or stateful address autoconfiguration.

If either the correct prefix is not received or the router 120 is unable to communicate with the WAN 205, at step 520 the second network address component 314 determines whether the previously assigned lease duration to the request client device 130 was the maximum lease duration. If not, at step 525 the second network address component 314 increases the lease duration. In one embodiment, the second network address component 314 may increase the duration in predefined incremental steps—i.e., linearly. In another embodiment, the duration may be increased exponentially. However, at step 530, the duration may be limited to a maximum lease duration. In one embodiment this limit could be the same as a typical lease duration in current DHCPv4 of around 24 hours.

Starting the lease duration at a minimum when the router 120 first determines that it switch communication protocols, uses the operation of DHCP to its advantage. Because DHCP requires the client device 130 to renew the lease based on an assigned duration, the second network address component 314 may assign an IPv4 address with a short duration so that an IPv6 address may be more quickly assigned if the communication failure that caused the switch is resolved. For example, if the WAN 205 connection is only lost for a few minutes, any client device assigned an IPv4 address during that time would not receive a new IPv6 address until the device asked to renew the lease but was denied. As typical in the art, that duration may be as long as 24 hours.

At the same, constantly forcing a large number of client devices 130 to frequently renew their leases may tax the limits of the second network address component 314 and thus the router 120. Accordingly, increasing the lease duration each time a client device seeks to renew it may prevent the renewal process from slowing down other functions performed by the router 120. For example, if the server that relays the prefix to the router 120 is nonfunctional for days, then allowing the lease durations to increase until they hit the maximum lease duration provides a compromise between communication failures that may be brief and ones that may persist over a significant length of time. In one embodiment, the lease duration may be varied only if the client device 130 supports both IPv4 and IPv6. Client devices 130 that only use IPv4 may immediately have the maximum lease duration assigned to their associated IP address.

At step 535, the second network address component 314 renews the lease and assigns a second lease duration. This duration may be the same as the previous duration (if the maximum duration was previously reached) or changed according to the desired rate of increase.

Although the previous embodiments discussed the lease duration as always increasing until the maximum duration was achieved, the present disclosure is not limited to such. For example, the reverse may be true for systems where the WAN 205 connection is known to fail for significant periods of time. In that case, the lease duration may be assigned to a maximum and then steadily decrease anticipating that the communication failure will end shortly. Moreover, the lease duration is not limited to always increasing or decreasing during consecutive renewals, but instead may increase for one renewal but then decrease the next (or vice versa).

The RFCs mentioned in this disclosure are available at the IETF website on the World Wide Web at http://www.ietf.org, and all—RFC 3513, RFC 4193, RFC 4862, RFC 3315, RFC 3736, and RFC 3456—are incorporated in their entirety herein by reference.

While the forgoing is directed to embodiments of the present disclosure, other and further embodiments of the disclosure may be devised without departing from the basic scope thereof. For example, aspects of the present disclosure, such as the first and second address components, may be implemented in hardware or software or in a combination of hardware and software. One embodiment of the disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present disclosure, are embodiments of the present disclosure.

The flowchart and block diagrams in the Figures illustrate the architecture, functionality and operation of possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for providing at least a portion of a network address associated with a communication network, comprising:
determining whether the portion of the network address was received via the communication network;
if the portion of the network address was received, transmitting to a computing device the portion of the network address based on a first communication protocol; and
otherwise, generating the network address based on a second communication protocol.

2. The method of claim 1 further comprising, receiving a request from the computing device for the portion of the network address based on the first communication protocol.

3. The method of claim 1 wherein the portion of the network address is a portion of an Internet Protocol (IP) address.

4. The method of claim 3, wherein the first communication protocol is IP version 6 (IPv6) and the second communication protocol is IP version 4 (IPv4).

5. The method of claim 1, further comprising, after transmitting the portion of the network address based on the first communication protocol:
determining whether data packets are successfully transmitted on the communication network using the first communication protocol;
if not, in response to a request to renew a lease associated with the portion of the network address, generating the network address based on the second communication protocol; and
otherwise, in response to the request to renew the lease associated with the portion of the network address, renewing the lease based on the first communication protocol.

6. The method of claim 1, wherein the portion of the network address based on the first communication protocol is a prefix of the network address, and wherein the network address based on the second communication protocol is the entire network address.

7. The method of claim 1 further comprising, after generating the portion of the network address based on the second communication protocol:
assigning a lease associated with the network address;
receiving a request to renew the lease;
after generating the network address based on the second communication protocol, determining if the portion of the network address was received via the communication network;
if so, after receiving the request, transmitting the portion of the network address using the first communication protocol; and
otherwise, after receiving the request, renewing the lease.

8. The method of claim 7, further comprising assigning a duration for which the lease is valid, wherein the duration is increased during a subsequent renewal request.

9. A network device that generates at least a portion of a network address associated with a communication network, comprising:
a network address assignor configured to:
determine whether the portion of the network address was received via the communication network;
if the portion of the network address was received, transmit to a computing device the portion of the network address based on a first communication protocol; and
otherwise, generates the network address based on a second communication protocol.

10. The network device of claim 9 wherein the network address assignor is further configured to receive a request from the computing device for the portion of the network address based on the first communication protocol.

11. The network device of claim 9 wherein the portion of the network address is a portion of an Internet Protocol (IP) address.

12. The network device of claim 11 wherein the first communication protocol is IP version 6 (IPv6) and the second communication protocol is IP version 4 (IPv4).

13. The network device of claim 9 the network address assignor is further configured to, after transmitting the portion of the network address based on the first communication protocol:
determining whether data packets are successfully transmitted on the communication network using the first communication protocol;
if not, in response to a request to renew a lease associated with the portion of the network address, generating the network address based on the second communication protocol; and
otherwise, in response to the request to renew the lease associated with the portion of the network address, renewing the lease based on the first communication protocol.

14. The network device of claim 9, wherein the network address assignor is further configured to, after generating the portion of the network address based on the second communication protocol:
assigning a lease associated with the network address;
receiving a request to renew the lease;
after generating the network address based on the second communication protocol, determining if the portion of the network address was received via the communication network;
if so, after receiving the request, transmitting the portion of the network address using the first communication protocol; and
otherwise, after receiving the request, renewing the lease.

15. The network device of claim 14, wherein the network address assignor is further configured to assign a duration for which the lease is valid, wherein the duration is increased during a subsequent renewal request.

16. A computer program product for generating at least a portion of a network address associated with a communication network, comprising:
computer code that determines whether the portion of the network address was received via the communication network;
computer code that, if the portion of the network address was received, transmits to a computing device the portion of the network address based on a first communication protocol; and
computer code that, otherwise, generates the network address based on a second communication protocol; and
a computer readable medium that stores the computer code.

17. The computer program product of claim 16, further comprising computer code that receives a request from the computing device for the portion of the network address based on the first communication protocol.

18. The computer program product of claim 16 wherein the portion of the network address is a portion of an Internet Protocol (IP) address, and wherein the first communication protocol is IP version 6 and the second communication protocol is IP version 4.

19. The computer program product of claim 16 further comprising computer code that, after transmitting the portion of the network address based on the first communication protocol:
determines whether data packets are successfully transmitted on the communication network using the first communication protocol;
if not, in response to a request to renew a lease associated with the portion of the network address, generates the network address based on the second communication protocol; and
otherwise, in response to the request to renew the lease associated with the portion of the network address, renews the lease based on the first communication protocol.

20. The computer program product of claim 16 further comprising computer code that, after generating the portion of the network address based on the second communication protocol:
assigns a lease associated with the network address;
receives a request to renew the lease;
after generating the network address based on the second communication protocol, determines if the portion of the network address was received via the communication network;
if so, after receiving the request, transmits the portion of the network address using the first communication protocol; and
otherwise, after receiving the request, renews the lease; and
assigns a duration for which the lease is valid, wherein the duration is increased during a subsequent renewal request.
